(19) United States
(12) Patent Application Publication
(10) Pub. No.: US 2010/0302981 A1
(43) Pub. Date: Dec. 2, 2010

(54) METHOD AND APPARATUS FOR ROAMING IN A WIRELESS NETWORK

(75) Inventors: Cheng Lung Tsai, Hsinchu County (TW); Chia Hsiang Hsu, Hsinchu County (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, Hsinchu County (TW)

(21) Appl. No.: 12/643,778

(22) Filed: Dec. 21, 2009

(30) Foreign Application Priority Data
Jun. 1, 2009 (TW) 098117950

(51) Int. Cl. H04W 36/30; H04W 52/02

(52) U.S. Cl. 370/311; 370/332

(57) ABSTRACT

An apparatus for roaming in a wireless network updates received signal strength indication (RSSI) values in accordance with all types of frames forwarded from the access point with which the apparatus associates. In addition, the apparatus actively forwards null frames to the access point with which the apparatus associates and updates RSSI values in accordance with acknowledgement frames forwarded from the access point.

### BACKGROUND OF THE INVENTION

1. Field of the Invention

The present invention relates to a communication system, and more particularly, to a method and apparatus for roaming in a wireless network.

2. Description of the Related Art

Wireless local area network (WLAN) technology is now widely used in various applications. Numerous organizations devote extensive resources to research seeking improvements in WLAN data communication quality. In a WLAN, a wireless transmit/receive unit (WTRU) may be located within communication ranges of several access points (APs). When the WTRU roams among various APs, the AP with which the WTRU associates may be adjusted in accordance with a location of the WTRU and the signal quality.

FIG. 1 illustrates a circumstance in which a station 13 roams from the communication range of an AP 11 to the communication range of an AP 12. As shown in FIG. 2, under the ideal circumstance of the station 13 moving from left to right as time goes by, received signal strength indication (RSSI) values for the AP 11 and the AP 12 are shown by curve 21 and curve 22, respectively. The RSSI values measured by the station 13 are determined in accordance with beacon frames forwarded periodically from the AP 11 and the AP 12, wherein the period for forwarding beacons is about 50 ms. The station 13 determines a connection object in accordance with an RSSI value. For example, before time Tₛ the station 13 associates with AP 11. After time Tₛ, because the RSSI value for receiving packets forwarded from the AP 11 is less than the RSSI value for receiving packets forwarded from the AP 12, the connection object with which the station associates is changed to the AP 12. Moreover, in a circumstance where the operation environment is changed, instead of decreasing gradually, the RSSI value for receiving packets forwarded from the AP 11 decreases suddenly and substantially. For example, the AP 11 is an AP set in a conference room. A user holding the station 13 leaves the conference room, closes the door and walks toward the AP 12. FIG. 3 shows the variations of the RSSI values under such circumstance for the AP 11 and AP 12 over time. In FIG. 3, when the door is closed (at time T₀), the RSSI value for the AP 11 has already decreased substantially. At time T₀, the station 13 should change the connection object to the AP 12. However, the current mechanism updates RSSI values for the AP 11 in accordance with beacon frames forwarded periodically from AP 11. Therefore, when the station 13 becomes aware that the RSSI value for AP 11 is quite low at time T₁, the station 13 has already been unable to communicate normally for the duration of T₁-T₀. Because the data forwarding and data receiving operations are interrupted during this period, important packets could be lost. Therefore, a method for updating RSSI values speedily for APs to achieve seamless roaming is needed by the market.

### SUMMARY OF THE INVENTION

A method and apparatus for roaming in a wireless network are disclosed which update received signal strength indication (RSSI) values in accordance with all types of frames forwarded from the access point with which the apparatus associates. In addition, the apparatus actively forwards null frames to the access point with which the apparatus associates and updates RSSI values in accordance with acknowledgement frames forwarded from the access point.

One embodiment of the present invention discloses a method for roaming in a wireless network, comprising the steps of: receiving a plurality of frames forwarded from a first access point; updating at least one received signal strength indication (RSSI) value in accordance with any frame of the plurality of frames; and associating with a second access point if the at least one RSSI value is less than a threshold value or if the period as of receiving the last frame exceeds a predetermined value.

Another embodiment of the present invention discloses a method for roaming in a wireless network, comprising the steps of: forwarding a null frame to a first access point periodically; receiving at least one frame forwarded from the first access point; updating at least one RSSI value in accordance with the at least one frame; and associating with a second access point if the at least one RSSI value is less than a threshold value or if the period as of receiving the last frame exceeds a predetermined value.

Another embodiment of the invention discloses an apparatus for roaming in a wireless network comprising a forwarding unit, a receiving unit, an updating unit, a determining unit and a switching unit. The forwarding unit is configured to forward at least one null frame to a first access point periodically. The receiving unit is configured to receive a plurality of frames forwarded from the first access point. The updating unit is configured to update at least one RSSI value in accordance with any frame of the plurality of frames. The determining unit is configured to determine whether the at least one RSSI value is less than a threshold value or whether at least one period as of receiving the last frame exceeds a predetermined value. The switching unit is configured to switch a connection to a second access point in accordance with a determination result of the determining unit.

### BRIEF DESCRIPTION OF THE DRAWINGS

The invention will be described according to the appended drawings in which:

FIG. 1 illustrates a circumstance in which a station roams from the communication range of one AP to the communication range of another AP;

FIG. 2 shows a circumstance of received signal strength indication values varying over time;

FIG. 3 shows another circumstance of received signal strength indication values varying over time;

FIG. 4 is a flowchart of roaming in a wireless network in accordance with an exemplary embodiment of the present invention;

FIG. 5 is a flowchart of roaming in a wireless network in accordance with another exemplary embodiment of the present invention; and

FIG. 6 is a block diagram of an apparatus in accordance with another exemplary embodiment of the present invention.

### PREFERRED EMBODIMENT OF THE PRESENT INVENTION

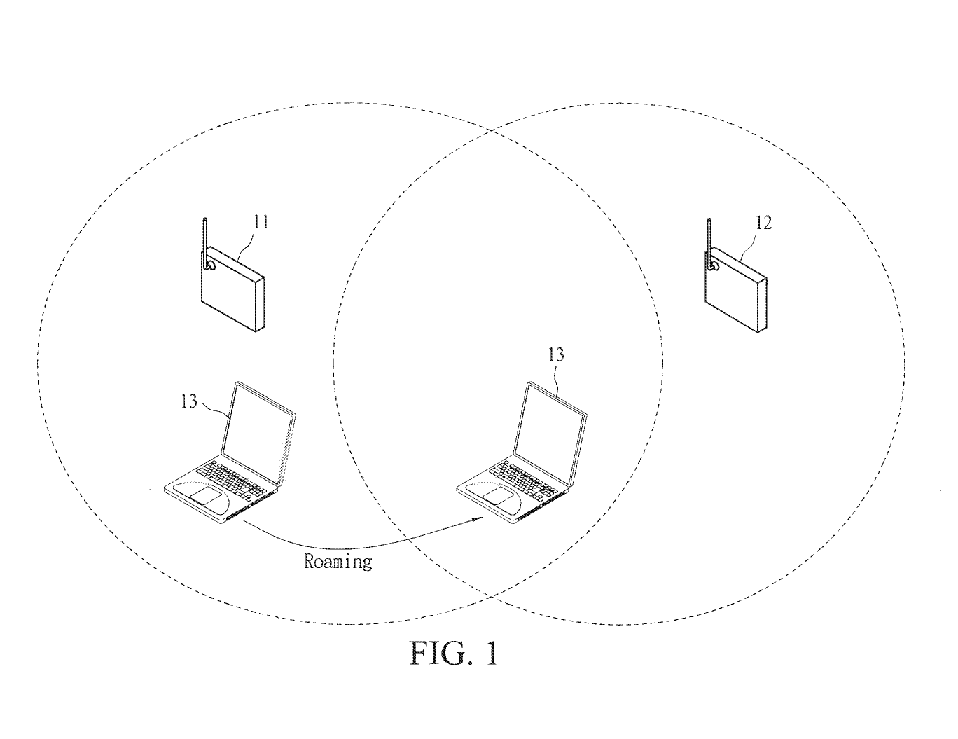

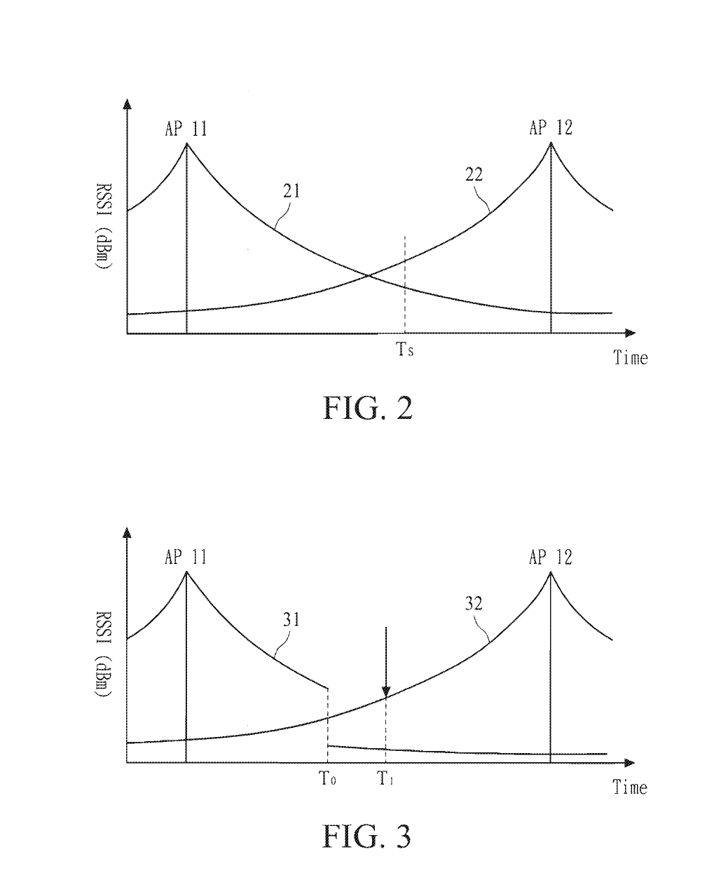

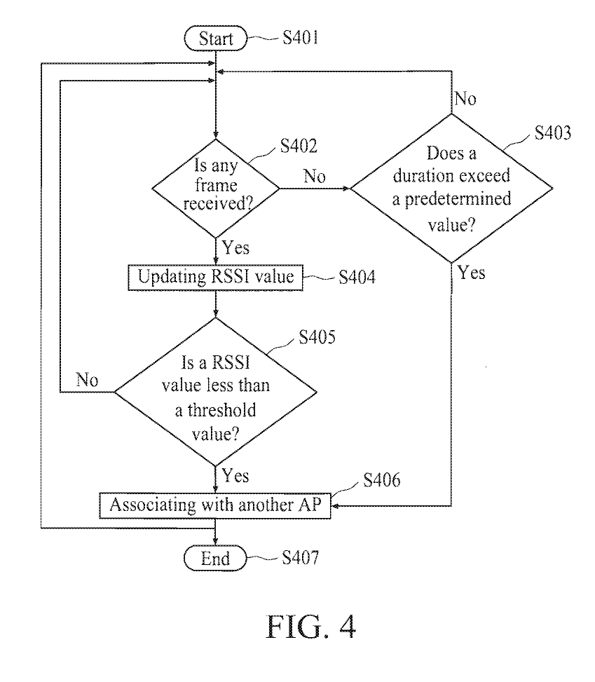

FIG. 4 is a flowchart of a method for roaming in a wireless network or wireless networks in accordance with an exemplary embodiment of the present invention. In order to enable those skilled in the art to practice the present invention in accordance with the exemplary embodiment, FIG. 1 and FIG. 4 are utilized to describe the procedure of a method for receiving frames. Assume that a station 13 has completed a standard channel scanning procedure. An AP candidate list is generated according to the standard channel scanning procedure, wherein the AP candidate list comprises an AP 11 and an AP 12. The station 13 is currently associating with the AP 11. The above-mentioned AP 11, AP 12 and the station 13 all comply with IEEE 802.11 standards. In step S401, the procedure of the embodiment is activated. Step S402 determines whether frames of any type are received from AP 11. The frame types include, but are not limited to, data frames, control frames, and management frames. The control frames include, for example, request-to-send (RTS) frames, clear-to-send (CTS) frames, acknowledgement frames or Power-Save Poll (PS-Poll) frames. The management frames include, for example, beacon frames, authentication frames, de-authentication frames, association request frames, association response frames, re-association request frames, re-association response frames, probe request frames, probe response frames or announcement traffic indication message (ATIM) frames. If the result from step S402 is NO, in step S403 the period as of receiving the last frame is checked to determine whether the period exceeds a predetermined value. The predetermined value can be less than or equal to 100 ms. In this embodiment, the predetermined value is set to 100 ms. If the result from step S403 is NO, the process returns to step S402. If the result from step S403 is YES, the connection for the station 13 is switched to the AP 12 in step S406. In step S402, if any frame is received, the station 13 updates a received signal strength indication (RSSI) value in accordance with the in frame in step S404. In step S405, the last RSSI value is checked to determine whether the value is less than a threshold value. If YES, the connection for the station 13 is switched to the AP 12 in step S406. The procedure can be ended in step S407, or steps S402-S406 can be repeated for updating additional RSSI values.

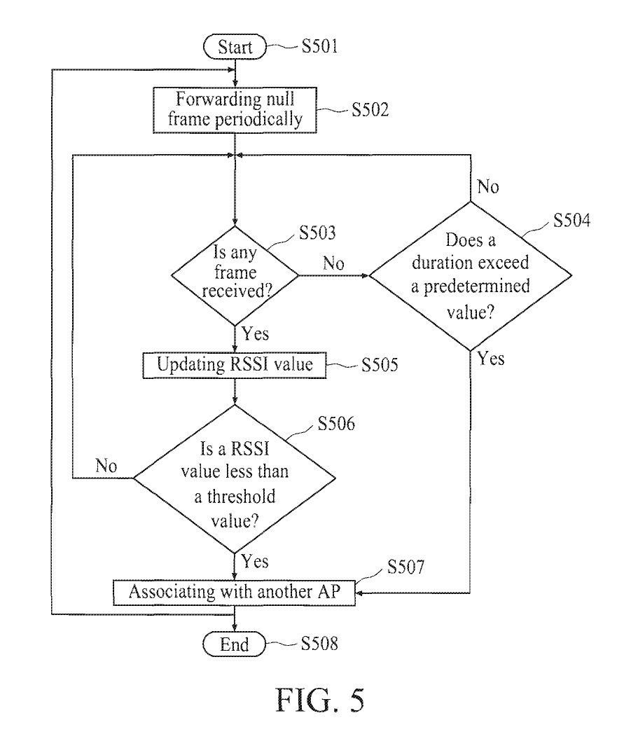

FIG. 5 is a flowchart of a method for roaming in a wireless network or wireless networks in accordance with another exemplary embodiment of the present invention. In order to enable those skilled in the art to practice the present invention in accordance with the exemplary embodiment, FIG. 1 and FIG. 5 are utilized to describe the procedure of a method for receiving frames. Assume that a station 13 has completed a standard channel scanning procedure. An AP candidate list is generated according to the standard channel scanning procedure, wherein the AP candidate list comprises an AP 11 and an AP 12. The station 13 is currently associating with the AP 11. The above-mentioned AP 11, AP 12 and the station 13 all comply with IEEE 802.11 standards. In step S501, the procedure of the embodiment is activated. In step S502, null frames are forwarded to the AP 11 periodically by the station 13. The period is less than 50 ms, The period is set to 50 ms in this embodiment. Step S503 determines whether an acknowledgement frame or a frame of another type is received from the AP 11. The frame in another type is, for example, a data frame, a control frame or a management frame. The control frame can be, for example, an RTS frame, a CTS frame, an acknowledgement frame or a PS-Poll frame. The management frame can be, for example, a beacon frame, an authentication frame, a de-authentication frame, an association request frame, an association response frame, a re-association request frame, a re-association response frame, a probe request frame, a probe response frame or an ATIM frame. If the result from step S503 is NO, in step S504 the period as of receiving the last frame is checked to determine whether the period exceeds a predetermined value. The predetermined value can be less than or equal to 100 ms. In this embodiment, the predetermined value is set to 100 ms. If the result from step S504 is NO, the process returns to step S502. If the result from step S504 is YES, the connection for the station 13 is switched to the AP 12 in step S507. In step S503, if any frame is received, the station 13 updates an RSSI value in accordance with the frame in step S505. In step S506, the last RSSI value is checked to determine whether the value is less than a threshold value. If YES, the connection for the station 13 is switched to the AP 12 in step S507. The procedure can be ended in step S508, or steps S502-S507 can be repeated for updating additional RSSI values.

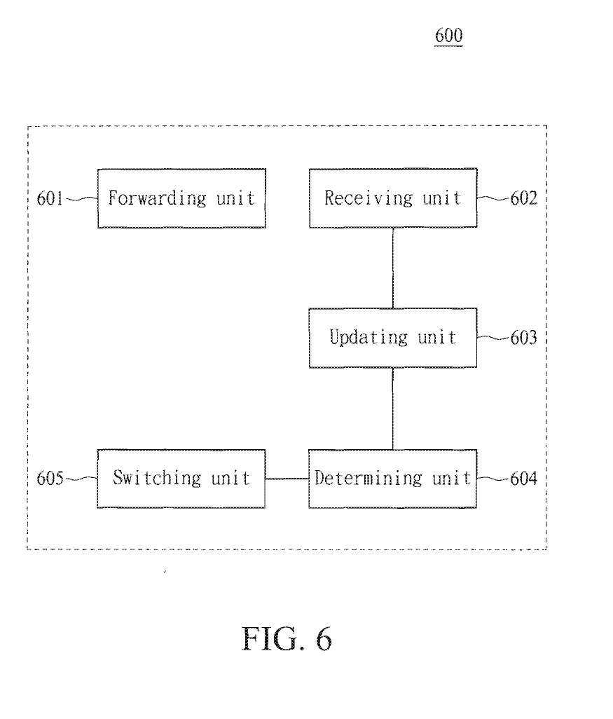

FIG. 6 is a block diagram of an apparatus for roaming in a wireless network or wireless networks in accordance with another exemplary embodiment of the present invention. FIG. 1 and FIG. 6 are utilized to describe the embodiment. The apparatus 600 for roaming in a wireless network comprises a forwarding unit 601, a receiving unit 602, an updating unit 603, a determining unit 604 and a switching unit 605. The forwarding unit 601 is configured to forward null frames to the AP 11 periodically. The period can be less than or equal to 50 ms. In this embodiment, the period is set to 50 ms. The receiving unit 602 is configured to receive frames forwarded from the AP 11. The updating unit 603 is configured to update RSSI values in accordance with the frames forwarded from the AP 11. The determining unit 604 is configured to determine whether any of the RSSI values is less than a threshold value or whether the period as of receiving the last frame exceeds a predetermined value. The predetermined value can be less than or equal to 100 ms. In this embodiment, the predetermined value is set to 100 ms. When a last RSSI value is less than a threshold value, or at least one period as of receiving the last frame exceeds a predetermined value, the switching unit 605 switches the connection to the AP 12.

The method and apparatus for roaming in a wireless network in accordance with the present invention update received signal strength indication (RSSI) values in accordance with all types of frames forwarded from the AP with which the apparatus associates. In addition, the apparatus actively forwards null frames to the AP with which the apparatus associates and updates RSSI values in accordance with acknowledgement frames forwarded from the access point. The method and apparatus for roaming in a wireless network in accordance with the present updates status for the AP with which the apparatus associates. When an RSSI value is less than a threshold value, or the period as of receiving the last frame exceeds a predetermined value, the apparatus switches the connection to another AP.

The above-described embodiments of the present invention are intended to be illustrative only. Numerous alternative embodiments may be devised by persons skilled in the art without departing from the scope of the following claims.

What is claimed is:

1. A method for roaming in a wireless network, comprising:
receiving a plurality of frames forwarded from a first access point;
updating at least one received signal strength indication (RSSI) value in accordance with any of the plurality of frames; and
associating with a second access point if the at least one RSSI value is less than a threshold value or if a period as of receiving the last frame exceeds a predetermined value.

2. The method of claim 1, further comprising generating a connection candidate list in accordance with a standard channel scanning procedure.

3. The method of claim 2, wherein the connection candidate list includes the first access point and the second access point.

4. The method of claim 1, wherein the plurality of frames belong to data frames, control frames, or management frames.

5. The method of claim 4, wherein the control frames are request-to-send (RTS) frames, clear-to-send (CTS) frames, acknowledgement frames or Power-Save Poll (PS-Poll) frames.

6. The method of claim 4, wherein the management frames are beacon frames, authentication frames, de-authentication frames, association request frames, association response frames, re-association request frames, re-association response frames, probe request frames, probe response frames or announcement traffic indication message (ATIM) frames.

7. The method of claim 1, wherein the predetermined value is less than or equal to 100 ms.

8. A method for roaming in a wireless network, comprising:
forwarding a null frame to a first access point periodically;
receiving at least one frame forwarded from the first access point;
updating at least one received signal strength indication (RSSI) value in accordance with the at least one frame; and
associating with a second access point if the at least one RSSI value is less than a threshold value or if a period as of receiving the last frame exceeds a predetermined value.

9. The method of claim 8, further comprising a step of generating a connection candidate list in accordance with a standard channel scanning procedure.

10. The method of claim 9, wherein the connection candidate list includes the first access point and the second access point.

11. The method of claim 8, wherein the at least one frame is an acknowledgement frame.

12. The method of claim 8, wherein the at least one frame is a data frame, a control frame, or a management frame.

13. The method of claim 12, wherein the control frame is a request-to-send (RTS) frame, a clear-to-send (CTS) frame, an acknowledgement frame or a Power-Save Poll (PS-Poll) frame.

14. The method of claim 12, wherein the management frame is a beacon frame, an authentication frame, a de-authentication frame, an association request frame, an association response frame, a re-association request frame, a re-association response frame, a probe request frame, a probe response frame or an announcement traffic indication message (ATIM) frame.

15. The method of claim 8, wherein the period is less than or equal to 50 ms and the predetermined value is less than or equal to 100 ms.

16. An apparatus for roaming in a wireless network, comprising:
a forwarding unit configured to forward at least one null frame to a first access point periodically;
a receiving unit configured to receive a plurality of frames forwarded from the first access point;
an updating unit configured to update at least one received signal strength indication (RSSI) value in accordance with any of the plurality of frames;
a determining unit configured to determine whether the at least one RSSI value is less than a threshold value or whether at least one period as of receiving the last frame exceeds a predetermined value; and
a switching unit configured to switch a connection to a second access point in accordance with a determination result of the determining unit.

17. The apparatus of claim 16, wherein the plurality of frames belong to data frames, control frames, or management frames.

18. The apparatus of claim 17, wherein the control frames are request-to-send (RTS) frames, clear-to-send (CTS) frames, acknowledgement frames or Power-Save Poll (PS-Poll) frames.

19. The apparatus of claim 17, wherein the management frames are beacon frames, authentication frames, de-authentication frames, association request frames, association response frames, re-association request frames, re-association response frames, probe request frames, probe response frames or announcement traffic indication message (ATM) frames.

20. The apparatus of claim 16, wherein the period is less than 50 ms and the predetermined value is less than 100 ms.
